(19) United States
(12) Patent Application Publication
(10) Pub. No.: US 2024/0166384 A1
(43) Pub. Date: May 23, 2024

(54) UNMANNED AIRCRAFT COMPRISING TWO RADARS

(71) Applicant: THALES, Meudon (FR)

(72) Inventors: Marc RIEDINGER, TOULOUSE (FR); Eric GUILLOUET, TOULOUSE (FR); Antoine BONNET, TOULOUSE (FR); Patrick GOUHIER, TOULOUSE (FR)

(21) Appl. No.: 18/388,171

(22) Filed: Nov. 8, 2023

(30) Foreign Application Priority Data
Nov. 18, 2022 (FR) 2212022

(51) Int. Cl. B64U 20/87; B64U 20/70; B64U 50/20; G01S 13/933

(52) U.S. Cl. CPC B64U 20/87; B64U 20/70; B64U 50/20; G01S 13/933

(57) ABSTRACT

An unmanned aircraft includes three parallel beams extending in at least one longitudinal direction X from a rear side to a front side of the aircraft, the central beam forming a main fuselage containing a powertrain, with a propeller of diameter D configured to be driven by the powertrain being attached to a front end of the central beam, each side beam being at a distance L/2 from the central beam and each side beam supporting a radar at a front end of the beam.

### CROSS-REFERENCE TO RELATED APPLICATION

This application claims priority to foreign French patent application No. FR 2212022, filed on Nov. 18, 2022, the disclosure of which is incorporated by reference in its entirety.

### FIELD OF THE INVENTION

The invention particularly relates to an aircraft of the unmanned aircraft type.

### BACKGROUND

An unmanned aircraft (i.e., a fixed-wing aerodyne) is called an “Unmanned Aerial Vehicle” or “UAV” or, more generally, an “aerial drone”.

Aviation regulations concerning aerial drones intended to enter civil airspace include very stringent requirements for detection and avoidance rates for all types of aircraft. Such regulations are defined by the European Union, among others. The aim is to maintain a high level of safety for the navigation of all airspace users by avoiding collision risks.

The safety level of aerial drones is often insufficient to allow them to be used over populations, or in non-segregated airspace, i.e., airspace that is not exclusively reserved for drone traffic. In order to be authorized to carry out such operations, aerial drones must be certified in order to guarantee a level of safety equal to or greater than that of manned aircraft.

Indeed, aerial drones are expected to be responsible for avoiding other aircraft, including non-collaborative aircraft, such as certain aeroplanes and gliders not equipped with transmitters, such as, for example, paragliders, powered ultralight aircraft (or “PULs”) or balloons. These requirements particularly lead to each aerial drone having to detect and track non-collaborative aircraft located within a field of view of at least +/−110 degrees horizontally and at least +/−15 degrees vertically, on either side of the axis of the aerial drone. Throughout the remainder of this application, the term “horizontal field of view” will be used to refer to the span of the field of view of the radar along a median plane of the aircraft including a longitudinal direction of the aircraft. This median plane notably corresponds to the horizontal plane when the aircraft is in flight. By contrast, the vertical field of view refers to the span of the field of view of the radar in a plane perpendicular to said median plane and that corresponds to the vertical plane when the aircraft is in flight.

Camera vision systems are well known among the known detection systems. However, camera vision still has difficulty distinguishing a moving aircraft against a terrestrial background. Only radar-type technologies provide a reliable detection rate below the horizon (−15 degrees vertically). However, the horizontal field of view of the radars generally does not exceed +/−60 degrees. This generally requires the use of two radars.

Furthermore, the radars must be positioned in such a way that their detection capabilities are not penalized by the structure of the aircraft. An unmanned aircraft is known that comprises three parallel beams extending in at least one longitudinal direction from a rear side to a front side of the aircraft. The central beam forms a main fuselage containing a powertrain. A propeller is attached to a front end of the central beam in order to be driven by the powertrain.

This raises the problem of knowing how to position radars on this type of aircraft without degrading the detection capabilities of the radars.

### SUMMARY OF THE INVENTION

To this end, the invention proposes an unmanned aircraft comprising three parallel beams extending in at least one longitudinal direction from a rear side to a front side of the aircraft, the central beam forming a main fuselage containing a powertrain, with a propeller of diameter D configured to be driven by said powertrain being attached to a front end of the central beam, each side beam being at a distance L/2 from said central beam and each side beam supporting a radar at a front end of the beam.

Thus, in the aircraft according to the invention, the radars are positioned on the tip of each side beam. This position is particularly advantageous since it allows any interference of the body of the aircraft with the radiation from the radars to be limited. Such a position is, for example, more advantageous than a position at the end of the main beam when said main beam is already occupied by the propeller.

According to one embodiment, the horizontal fields of view of the radars have a maximum semi-aperture angle a and the radars are oriented so that their respective horizontal field of view is outwardly oriented at an angle m relative to the longitudinal direction.

According to an alternative embodiment, the horizontal fields of view of the radars respectively have a peripheral angular zone having an angle δa, in which zone the sensitivity of the radar is attenuated relative to the sensitivity of the radar in a central zone of the horizontal field of view, with the angle m relative to the longitudinal direction being equal to the difference between the maximum semi-aperture angle a and the angle δa of said peripheral angular zone.

According to one embodiment, the aircraft comprises a wing unit crossing said beams in a substantially perpendicular manner, with the distal ends of the wing unit being at a distance b/2 relative to the central beam, and at a distance PW relative to the front end of the central beam in said longitudinal direction.

According to one embodiment, the front ends of the side beams are located behind the front end of the central beam in a rear-front direction of the aircraft, at a distance OP from the front end of the central beam in said longitudinal direction.

According to an alternative embodiment, said distance OP between the front end of the central beam and the front ends of the side beams in said longitudinal direction is configured so that said propeller is outside the horizontal field of view of the radars.

According to an alternative embodiment, said distance OP between the front end of the central beam and the front ends of the side beams in said longitudinal direction is configured so that said wing unit is outside the horizontal field of view of the radars.

According to an alternative embodiment, the angle m relative to said longitudinal direction is configured so that said wing unit is outside the horizontal field of view of the radars.

According to an alternative embodiment, the angle m relative to said longitudinal direction is configured so that said propeller is outside the horizontal field of view of the radars.

According to an alternative embodiment, the angle m of the horizontal fields of view of the radars relative to the longitudinal direction, the maximum semi-aperture angle a of the radars, the distance b/2 of the distal ends of the wing unit relative to the central beam, the diameter D of the propeller, the distance OP between the front end of the central beam and the front ends of the side beams in said longitudinal direction, and the distance PW between the distal ends of the wing unit and the front end of the central beam in said longitudinal direction are such that:

$$\frac{D}{2} < \frac{L}{2} - OP \times tan ( a - m ) \qquad [ Math 1 ]$$

$$( \frac{b}{2} - \frac{L}{2} ) \times tan ( a + m - 90 ) < PW - OP . \qquad [ Math 2 ]$$

According to one embodiment, said side beams form secondary fuselages of the aircraft, and preferably respectively comprise an electronic control unit for their respective radar.

According to one embodiment, the aircraft comprises a control unit configured to combine the data originating from the radars supported by said side beams, or to combine the data originating from the radars and the data originating from at least one other sensor.

### BRIEF DESCRIPTION OF THE DRAWINGS

Further features and advantages of the present invention will become more clearly apparent upon reading the following description with reference to the following appended figures:

FIG. 1 shows an example of an aircraft according to the invention;

FIG. 2 illustrates a method for combining data originating from radars of the example of an aircraft of FIG. 1.

### DETAILED DESCRIPTION

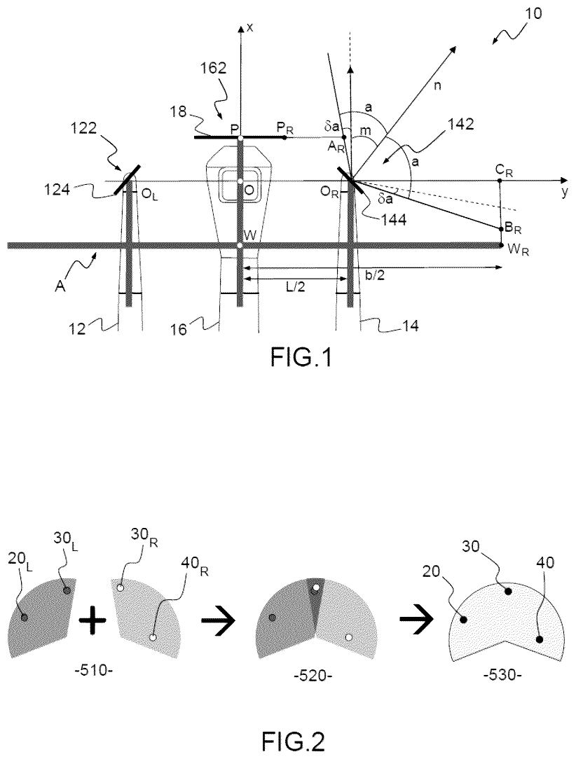

FIG. 1 shows a schematic top view of the front side of an example of an unmanned aircraft 10 according to the invention. The aircraft 10 comprises three parallel beams 12, 14, 16 that extend in a longitudinal direction X of the aircraft 10.

The central beam 16 forms a main fuselage of the aircraft 10. It comprises a powertrain that drives a propeller 18 attached to a front end 162 of the central beam 16. The side beams 12, 14 are each at a distance L/2 from the central beam 16. Notably, the distance L/2 is measured from a central axis of the central beam 16 extending in the longitudinal direction X. The beams 12, 14, 16 extend from the rear to the front of the aircraft 10. Notably, they extend along a longitudinal plane of the aircraft 10. When the aircraft 10 is in flight in a horizontal plane, the beams 12, 14, 16 are then located at the same altitude. This limits the overall dimensions of the aircraft 10.

Each side beam 12, 14 supports a radar 124, 144 at its front end 122, 142. Thus, the radars 124, 144 are positioned on the aircraft 10 using the specific structural features thereof. The side beams 12, 14 are primarily used to stabilize the aircraft 10 and for the aerodynamics thereof. Integrating the radars 124, 144 at their front ends 122, 142 takes advantage of a privileged location on the aircraft 10 where interactions with the body of the aircraft 10 are limited. Thus, a risk of degrading the detection capabilities of the radars 124, 144 is reduced. In particular, the radars 124, 144 are integrated into their respective beams 122, 142, which improves the aerodynamic drag of the aircraft 10.

The side beams 12, 14 notably form secondary fuselages of the aircraft 10. They can each house an electronic control unit for their respective radar 124, 144.

In particular, the centre of rotation P of the propeller 18 is at the end of the central beam 162. However, this position is the position that allows the radars to most reliably detect surrounding objects. However, due to the presence of the propeller 18, positioning the radars 124, 144 at the end of the side beams 12, 14 is an advantageous compromise that preserves the structure of the aircraft 10, while allowing detection of surrounding objects.

Notably, in order to further limit the interference of the body of the aircraft 10 with the radiation from the radars 124, 144, the horizontal field of view of each radar 124, 144 is outwardly oriented at an angle m relative to the longitudinal direction X of the aircraft 10. In other words, each radar 124, 144 is oriented so that the bisecting line n of the horizontal field of view forms an angle m with the longitudinal direction X away from the central beam 16. The bisecting line n of the horizontal field of view notably corresponds to a direction normal to the focal point O_{R}, O_{L} of the radar 124, 144. This orientation of the radars 124, 144 also allows the total horizontal field of view obtained with the two radars 124, 144 to be increased. In particular, the angle m is non-zero and has the same absolute value for both radars 124, 144.

Typically, the horizontal field of view of a radar has a maximum semi-aperture angle a that characterizes the angle 2a beyond which the sensitivity of the radar is too low to be used. The horizontal field of view of each radar 124, 144 therefore has a maximum semi-aperture angle a on either side of the bisecting line n of the radar 124, 144. However, at the edge of the horizontal field of view, there can be an angular zone with an angle of δa, in which zone detection remains less accurate. In this peripheral angular zone with an angle of δa, the sensitivity of the radar 124, 144 is attenuated compared to the sensitivity of the radar 124, 144 in a central zone of the horizontal field of view, i.e., in the vicinity of the normal n of the radar 124, 144. Such a peripheral angular zone with an angle of δa is notably due to the features of the external detection lobes.

Consequently, with a view to improving the detection of objects in front of the aircraft 10, an overlap can be provided for the horizontal fields of view of the radars 124, 144. The angle m of the horizontal field of view relative to the longitudinal direction X then is not equal to the maximum semi-aperture angle a, but is equal to the difference between the maximum semi-aperture angle a and the angle δa of the peripheral angular zone, located at the edge of the horizontal field of view. The maximum semi-aperture angle a can be equal to 60° and the angle δa of the peripheral angular zone can be equal to 10°.

When the radars 124, 144 operate, notably during a flight of the aircraft 10, their data is preferably combined. As illustrated, for example, in FIG. 2, in a first step 510, each radar provides “tracks” 20_{L}, 30_{L}, 30_{R}, 40_{R} that correspond to the echoes of the objects detected in their respective field of view. In a step 520, the data is consolidated. However, given the limited precision of the radars 124, 144 in their overlap zone, the tracks 30_{L}, 30_{R} located in this zone and corresponding to the same object will not be perfectly superimposed. Preferably, during a step 530, the combining method therefore takes into account several criteria for identifying the tracks that can originate from the same object 10, 30, 40. Such criteria for these tracks include, for example, their relative, radial and/or angular distance, their velocity vector, in particular its radial component, which is easier to precisely measure using the Doppler effect. Another criterion is, for example, how these parameters change over time. In an alternative embodiment, combining data also takes into account data originating from at least one other sensor. Such a sensor is notably mounted on the aircraft 10, for example an ADS-B (Automatic Dependent Surveillance-Broadcast) receiver, a FLARM (Flight alarm) device, or a transponder. Alternatively, the sensor can be outside the aircraft, on the ground for example.

In particular, the front ends 122, 142 of the side beams 12, 14 are located behind the front end 162 of the central beam 16 in a rear-front direction of the aircraft 10. The front ends 122, 142 of the side beams 12, 14 are located at a distance OP from the end 162 of the central beam 16 in the longitudinal direction X.

Notably, the aircraft 10 comprises a wing unit A, preferably located on a front side of the aircraft 10. In particular, the wing unit A comprises two wings located on either side of the central beam 16. The wing unit A crosses the beams 12, 14, 16 and is substantially perpendicular to them. Only the span 2WW_{R} of the wing unit A is shown in FIG. 1, with a distance b/2 between one end W_{R} of the wing unit A and the central beam 16. Notably, the distance b/2 is measured from a central axis of the central beam 16 extending in the longitudinal direction X. The distal ends W_{R} of the wing unit A are at a distance PW from the front end 162 of the central beam 16 in said longitudinal direction X. In particular, the beams 12, 14, 16 are connected to each other by the wing unit A and by a tail unit, not shown in FIG. 1.

The positions of the radars 124, 144 can be adapted to take into account the position of the ends 122, 142 of the side beams 12, 14 behind the end 162 of the central beam 16. The positions of the radars 124, 144 also can be adapted to take into account the presence of the wing unit A.

Thus, preferably, the angle m of each radar 124, 144 relative to the longitudinal direction X is selected so that the propeller 18 remains outside the horizontal field of view of the radars 122, 124. Masking the radars 122, 124 by the propeller 18 also can be avoided by adapting the distance OP between the end 162 of the central beam 16 and the ends 122, 142 of the side beams 12, 14. This distance OP is notably assessed in the longitudinal direction X.

In particular, the diameter PP_{R} of the propeller 18 is preferably less than a distance PAR between a centre P of the propeller 18 and the horizontal field of view of the radar 124, 144 along a perpendicular to the longitudinal direction X passing through the centre P of the propeller 18. Thus, masking the radars 124, 144 with the propeller 18 is avoided.

Furthermore, the angle m of each radar 124, 144 relative to the longitudinal direction X is preferably selected so that the wing unit A remains outside the horizontal field of view of the radars 124, 144. The distance OP between the end 162 of the central beam 16 and the ends 122, 142 of the side beams 12, 14 also can be adapted in the longitudinal direction X.

In particular, considering a perpendicular Y to the longitudinal axis X passing through a focal point O_{R}, O_{L} of the radar 124, 144, the projection C_{R} of the end W_{R} of the wing unit A on the axis Y allows the angle m of the corresponding radar 124, 144 to be adjusted. Similarly, the intersection B_{R} of the edge of the horizontal field of view of the radar 124, 144 with a straight line passing through the projection C_{R} and parallel to the longitudinal axis X allows the angle m of the corresponding radar 124, 144 to be adjusted. Thus, the distance between this projection C_{R} and this intersection B_{R} is preferably less than the distance between the projection C_{R} and the end W_{R} of the wing unit A. Thus, masking the radars 124, 144 with the wing unit A is avoided.

Preferably, the angle m of the radars 124, 144 and the position of the front ends 122, 142 of the side beams 12, 14 are adapted so as to take into account the presence of the wing unit A and the propeller 18. In particular, the angle m of the horizontal fields of view of the radars 124, 144 relative to the longitudinal direction X, the maximum semi-aperture angle a of the radars 124, 144, the distance b/2 of the distal ends W_{R} of the wing unit A relative to the central beam 16, the diameter D of the propeller 18, the distance OP of the front end 162 of the central beam 16 from the front ends 122, 142 of the side beams 12, 14 in the longitudinal direction X, and the distance PW between the distal ends W_{R} of the wing unit A and the front end 162 of the central beam 16 in said longitudinal direction X, are such that they comply with the following relationships:

$$\frac{D}{2} < \frac{L}{2} - OP \times tan ( a - m ) \qquad [ Math 3 ]$$

$$( \frac{b}{2} - \frac{L}{2} ) \times tan ( a + m - 90 ) < PW - OP . \qquad [ Math 4 ]$$

The present invention has been described in relation to a particular example. However, features can be omitted in an example of an aircraft according to the invention as defined by the claims.

1. An unmanned aircraft comprising three parallel beams extending in at least one longitudinal direction X from a rear side to a front side of the aircraft,
the central beam forming a main fuselage containing a powertrain, with a propeller of diameter D configured to be driven by said powertrain being attached to a front end of the central beam,
each side beam being at a distance L/2 from said central beam and
each side beam supporting a radar at a front end of the beam.

2. The aircraft according to claim 1, wherein the horizontal fields of view of the radars have a maximum semi-aperture angle a, and the radars are oriented so that their respective horizontal field of view is outwardly oriented at an angle m relative to the longitudinal direction X.

3. The aircraft according to claim 2, wherein the horizontal fields of view of the radars respectively have a peripheral angular zone having an angle δa, in which zone the sensitivity of the radar is attenuated relative to the sensitivity of the radar in a central zone of the horizontal field of view, with the angle m relative to the longitudinal direction X being equal to the difference between the maximum semi-aperture angle a and the angle δa of said peripheral angular zone.

4. The aircraft according to claim 1, comprising a wing unit A crossing said beams in a substantially perpendicular manner, with the distal ends W_{R} of the wing unit A being at a distance b/2 relative to the central beam, and at a distance PW relative to the front end of the central beam in said longitudinal direction X.

5. The aircraft according to claim 1, wherein the front ends of the side beams are located behind the front end of the central beam in a rear-front direction of the aircraft, at a distance OP from the front end of the central beam in said longitudinal direction X.

6. The aircraft according to claim 5, wherein said distance OP between the front end of the central beam and the front ends of the side beams in said longitudinal direction X is configured so that said propeller is outside the horizontal field of view of the radars.

7. The aircraft according to claim 4, wherein said distance OP between the front end of the central beam and the front ends of the side beams in said longitudinal direction X is configured so that said wing unit A is outside the horizontal field of view of the radars.

8. The aircraft according to claim 2, comprising a wing unit A crossing said beams in a substantially perpendicular manner, with the distal ends W_{R} of the wing unit A being at a distance b/2 relative to the central beam, and at a distance PW relative to the front end of the central beam in said longitudinal direction X, and wherein the angle m relative to said longitudinal direction X is configured so that said wing unit A is outside the horizontal field of view of the radars.

9. The aircraft according to claim 2, wherein the front ends of the side beams are located behind the front end of the central beam in a rear-front direction of the aircraft, at a distance OP from the front end of the central beam in said longitudinal direction X, and wherein the angle m relative to said longitudinal direction X is configured so that said propeller 18 is outside the horizontal field of view of the radars.

10. The aircraft according to claim 2, comprising a wing unit A crossing said beams in a substantially perpendicular manner, with the distal ends WR of the wing unit A being at a distance b/2 relative to the central beam, and at a distance PW relative to the front end of the central beam in said longitudinal direction X,
wherein the front ends of the side beams are located behind the front end of the central beam in a rear-front direction of the aircraft, at a distance OP from the front end of the central beam in said longitudinal direction X, and
wherein the angle m of the horizontal fields of view of the radars relative to the longitudinal direction X, the maximum semi-aperture angle a of the radars, the distance b/2 of the distal ends W_{R} of the wing unit A relative to the central beam, the diameter D of the propeller, the distance OP between the front end of the central beam and the front ends of the side beams in said longitudinal direction X, and the distance PW between the distal ends W_{R} of the wing unit and the front end of the central beam in said longitudinal direction X are such that:
$$\frac{D}{2} < \frac{L}{2} - OP \times tan ( a - m )$$
$$and ( \frac{b}{2} - \frac{L}{2} ) \times tan ( a + m - 90 ) < PW - OP .$$

11. The aircraft according to claim 1, wherein said side beams form secondary fuselages of the aircraft, and preferably respectively comprise an electronic control unit for their respective radar.

12. The aircraft according to claim 1, comprising a control unit configured to combine the data originating from the radars supported by said side beams, or to combine the data originating from the radars and the data originating from at least one other sensor.
